(19) United States
(12) Patent Application Publication
(10) Pub. No.: US 2022/0078979 A1
(43) Pub. Date: Mar. 17, 2022

(54) TRELLIS ASSEMBLY

(71) Applicant: Patrick Scott Brady, Buffalo, NY (US)

(72) Inventor: Patrick Scott Brady, Buffalo, NY (US)

(21) Appl. No.: 17/445,769

(22) Filed: Aug. 24, 2021

Related U.S. Application Data
(60) Provisional application No. 63/078,487, filed on Sep. 15, 2020.

(51) Int. Cl. A01G 17/06; F16B 5/00

(52) U.S. Cl. CPC A01G 17/06; F16B 5/0056

(57) ABSTRACT

A trellis assembly, including at least one post including a first end and a second end, and a first frame removably connected to the post, the first frame including at least one first support member forming a first geometry, a first front surface, a first rear surface, a first radially outward facing surface, and a first radially inward facing surface.

### CROSS-REFERENCE TO RELATED APPLICATIONS

This application claims the benefit under 35 U.S.C. § 119(e) of U.S. Provisional Patent Application No. 63/078,487, filed Sep. 15, 2020, which application is incorporated herein by reference in its entirety.

### FIELD

The present disclosure relates to the field of trellises, and more particularly, to a trellis assembly that is adjustable in size and shape.

### BACKGROUND

A trellis (treillage) is an architectural structure, usually made from an open framework or lattice of interwoven or intersecting pieces of wood, bamboo, or metal that is normally made to support and display climbing plants, especially shrubs.

There are many types of trellis for different places and for different plants, from agricultural types, especially in viticulture, which are covered at vine training systems, to garden uses for climbers such as grapevines, clematis, ivy, and climbing roses or other support based growing plants. The rose trellis is especially common in Europe and other rose-growing areas, and many climbing rose varieties require a trellis to reach their potential as garden plants. Some plants will climb and wrap themselves round a trellis without much artificial help being needed while others need training by passing the growing shoots through the trellis and/or tying them to the framework.

Trellises can also be referred to as panels, usually made from interwoven wood pieces, attached to fences or the roof or exterior walls of a building. A pergola usually refers to trellis-work that is laid horizontally above head height to provide a partial “roof” in a garden (pergolas are also used in agricultural settings).

However, current trellis designs are not adjustable for in home use or for specific climbing plants.

Thus, there is a long felt need for a trellis assembly that is adjustable in shape and side to accommodate various climbing plants.

### SUMMARY

According to aspects illustrated herein, there is provided a trellis assembly, comprising at least one post including a first end and a second end, and a first frame removably connected to the post, the first frame including at least one first support member forming a first geometry, a first front surface, a first rear surface, a first radially outward facing surface, and a first radially inward facing surface.

In some embodiments, the trellis assembly further comprises a second frame removably connectable to the first frame, the second frame including at least one second support member forming a second geometry, a second front surface, a second rear surface, a second radially outward facing surface, and a second radially inward facing surface. In some embodiments, the at least one second support member comprises a hole and the second end engages the hole. In some embodiments, the second frame further comprises a wall connected to the second rear surface and enclosing a side of the second frame. In some embodiments, the second geometry is different than the first geometry. In some embodiments, the second geometry is the same as the first geometry.

In some embodiments, the first frame further comprises a first connector port, the second frame further comprises a second connector port, and a connector engages the first connector port and the second connector port to removably connect the first frame to the second frame. In some embodiments, at least one of the first connector port and the second connector port comprises a hole arranged in the first front surface. In some embodiments, the connector comprises a backing, a first engaging member protruding from the backing and operatively arranged to engage the first connector port, and a second engaging member protruding from the backing and spaced apart from the first engaging member, the second engaging member operatively arranged to engage the second connector port. In some embodiments, the connector comprises a first engaging member operatively arranged to engage the first connector port, and a second engaging member arranged perpendicular to the first engaging member, the second engaging member operatively arranged to engage the second connector port.

In some embodiments, at least one of the first end and the second end is tapered. In some embodiments, one of the first end and the second end comprises at least one barb. In some embodiments, the trellis assembly further comprises a third frame removably connectable to the first frame and the second frame, wherein the third frame includes at least one third support member forming a third geometry, and the third geometry is different than the first geometry and the second geometry. In some embodiments, the trellis assembly further comprises a plant height indicator removably connectable to the first frame, the second frame, and the third frame.

According to aspects illustrated herein, there is provided a trellis assembly, comprising a first frame, including at least one first support member forming a first geometry, a first front surface, and a first rear surface, a second frame removably connectable to the first frame, the second frame including at least one second support member forming a second geometry, a second front surface, and a second rear surface, and at least one post including a first end and a second end removably connected to the first frame.

In some embodiments, the second geometry is different than the first geometry. In some embodiments, the first front surface comprises a first connector port, the second front surface comprises a second connector port, and a connector engages the first connector port and the second connector port to removably connect the first frame to the second frame. In some embodiments, the connector comprises a backing, a first engaging member protruding from the backing and operatively arranged to engage the first connector port, and a second engaging member protruding from the backing and spaced apart from the first engaging member, the second engaging member operatively arranged to engage the second connector port. In some embodiments, the connector comprises a first engaging member operatively arranged to engage the first connector port, and a second engaging member arranged perpendicular to the first engaging member, the second engaging member operatively arranged to engage the second connector port. In some embodiments, the trellis assembly further comprises a third frame removably connectable to the first frame and the second frame, wherein the third frame includes at least one third support member forming a third geometry, and the third geometry is different than the first geometry and the second geometry.

According to aspects illustrated herein, there is provided a modular trellis assembly for gardening, comprising at least one base, at least one post removably connectable to the at least one base, and at least one frame removably connectable to the at least one base, wherein the at least one frame is operatively arranged to support climbing plants. In some embodiments, the at least one post is connected to the at least one base via a connection sleeve. In some embodiments, the at least one frame is connected to the at least one base via an “H” connector.

The trellis assembly of the present disclosure comprises polygon shaped modules that are made up of one male element and one female element. Each module has a female inset “T” design. These female insets are found centered on every side on the polygon. Individual modules connect to each other with male “H” connectors. These connectors fit in flush to each inset side of the hexagon. The stake of the trellis is comprised of a triangle shaped mount, with two primary protrusions. A hollow connector and secondary stake mount to the primary stake.

These and other objects, features, and advantages of the present disclosure will become readily apparent upon a review of the following detailed description of the disclosure, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a perspective view of a trellis assembly;

FIG. 2 is a perspective view of a frame shown in FIG. 1;

FIG. 3 is a perspective view of a frame shown in FIG. 1;

FIG. 4 is a perspective view of a frame shown in FIG. 1;

FIG. 5 is a perspective view of a post shown in FIG. 1;

FIG. 6 is a perspective view of a connector shown in FIG. 1;

FIG. 7 is a perspective view of a connector shown in FIG. 1; and,

FIG. 8 is a perspective view of an indicator shown in FIG. 1.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” is used herein.

It should be appreciated that the term “member” or “support member” as used herein is synonymous with beam, arm, strut, or any other suitable structural member used to support growing plants. It should further be appreciated that the term “member” can mean a rigid or semi-rigid structure.

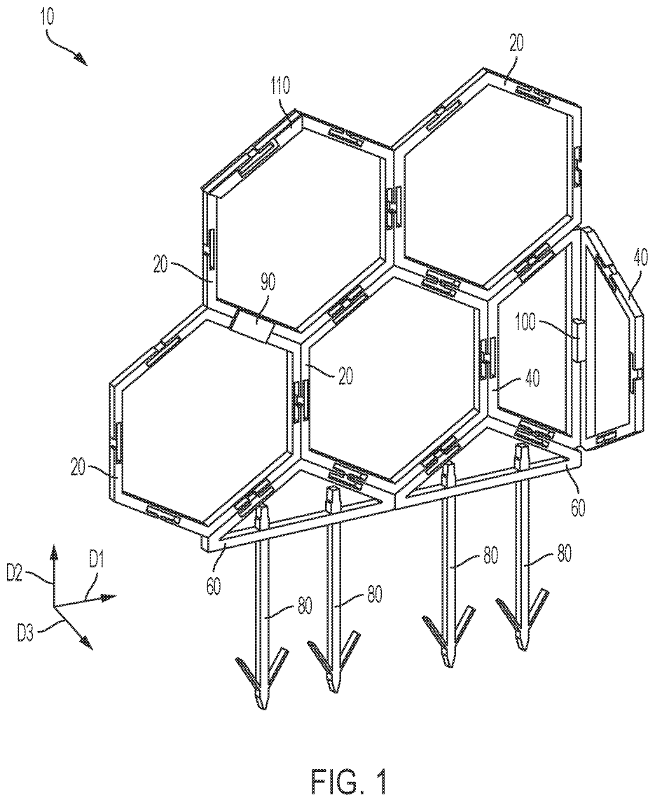

Adverting now to the figures, FIG. 1 is a perspective view of trellis assembly 10. Trellis assembly 10 comprises at least one frame or lattice, for example, frame or lattice 20, frame or lattice 40, and/or frame or lattice 60, and at least one post 80. In some embodiments, trellis assembly 10 comprises one or more connectors 90 for connecting frames 20, 40, 60 in first direction D1 and second direction D2 (i.e., the X and Y plane). In some embodiments, trellis assembly 10 comprises one or more connectors 100 for connecting frames 20, 40, 60 in second direction D2 and third direction D3 (i.e., the Y and Z plane). In some embodiments, trellis assembly 10 further comprises height indicator 110. In some embodiments, the components of trellis assembly 10 comprise polylactic acid (PLA).

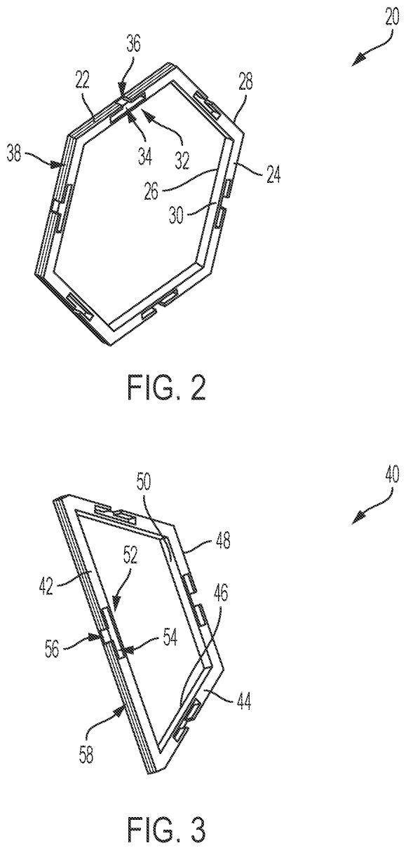

FIG. 2 is a perspective view of frame or lattice 20. Frame 20 comprises at least one support or rigid or semi-rigid member 22 forming a first geometry. In some embodiments, frame 20 comprises six support members 22 forming a hexagon. However, it should be appreciated that frame 20 may have any number of support members 22 forming any geometry suitable for building and expanding a custom trellis. For example, frame 20 may comprise a plurality of support members 22 forming a rectangle, square, triangle, trapezoid, parallelogram, rhombus, etc. In some embodiments, frame 20 comprises a single support member 22 forming a circle, oval, ellipsoid, etc. Frame 20 comprises surface 24, surface 26, radially outward facing surface 28, radially inward facing surface 30, and at least one connector port 32. In some embodiments, radially outward facing surface 28 on at least one rigid member 22 comprises one or more radially outward extending ridges 38. Ridges 38 are operatively arranged to engage ridges on an adjacently connected frame to facilitate a tighter fit and stabilization between frames.

Connector port 32 is operatively arranged to be engaged by connector 90, 100 to connect frames 20, 40, 60 together. In some embodiments, frame 20 comprises at least two connector ports 32, one connector port 32 for connecting frame 20 to frame 60 and the other connector port 32 for connecting frame 20 to another frame 20 or frame 40. In some embodiments, and as shown, connector port 32 comprises hole 34 and hole 36. Hole 34 extends from surface 24 toward surface 26. In some embodiments, hole 34 extends from surface 24 partially toward surface 26. In some embodiments, hole 34 extends from surface 24 completely to surface 26 (i.e., a through-hole extending completely through support member 22). Hole 36 extends from radially outward facing surface 28 to hole 34. In some embodiments, hole 36 extends from surface 24 partially toward surface 26. In some embodiments, hole 36 extends from surface 24 completely to surface 26 (i.e., a through-hole extending completely through support member 22). In some embodiments, and as shown, hole 34 has a first width and hole 36 has a second width, the first width being greater than the second width.

FIG. 3 is a perspective view of frame 40. Frame 40 comprises at least one support or rigid or semi-rigid member 42 forming a second geometry. In some embodiments, the second geometry (of frame 40) is different than the first geometry (of frame 20). In some embodiments, the second geometry (of frame 40) is the same as the first geometry (of frame 20). In some embodiments, frame 40 comprises four support members 42 forming a trapezoid or a half hexagon. However, it should be appreciated that frame 40 may have any number of support members 42 forming any geometry suitable for building and expanding a custom trellis. For example, frame 40 may comprise a plurality of support members 42 forming a rectangle, square, triangle, hexagon, parallelogram, rhombus, etc. In some embodiments, frame 40 comprises a single support member 42 forming a circle, oval, ellipsoid, etc. Frame 40 comprises surface 44, surface 46, radially outward facing surface 48, radially inward facing surface 50, and at least one connector port 52. In some embodiments, radially outward facing surface 48 on at least one support member 42 comprises one or more radially outward extending ridges 58. Ridges 58 are operatively arranged to engage ridges on an adjacently connected frame to facilitate a tighter fit and stabilization between frames.

Connector port 52 is operatively arranged to be engaged by connector 90, 100 to connect frames 20, 40, 60 together. In some embodiments, frame 40 comprises at least two connector ports 52. In some embodiments, and as shown, connector port 52 comprises hole 54 and hole 56. Hole 54 extends from surface 44 toward surface 46. In some embodiments, hole 54 extends from surface 44 partially toward surface 46. In some embodiments, hole 54 extends from surface 44 completely to surface 46 (i.e., a through-hole extending completely through support member 42). Hole 56 extends from radially outward facing surface 48 to hole 54. In some embodiments, hole 56 extends from surface 44 partially toward surface 46. In some embodiments, hole 56 extends from surface 44 completely to surface 46 (i.e., a through-hole extending completely through support member 42). In some embodiments, and as shown, hole 54 has a first width and hole 56 has a second width, the first width being greater than the second width.

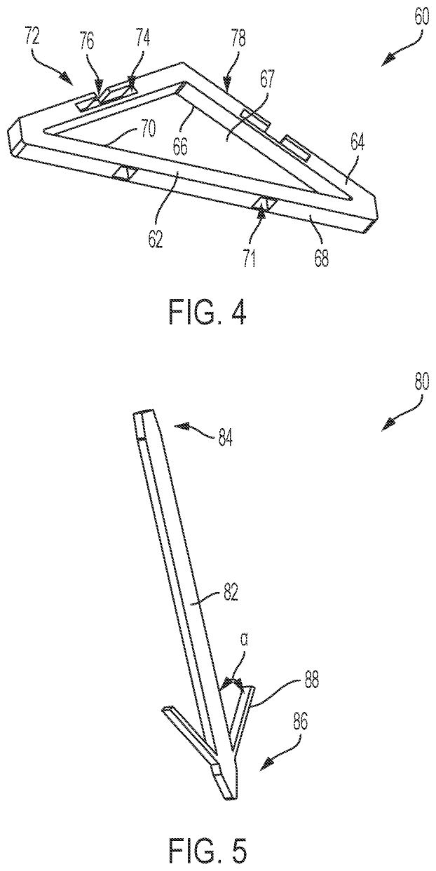

FIG. 4 is a perspective view of frame or base 60. Frame 60 comprises at least one support or rigid or semi-rigid member 62 forming a third geometry. In some embodiments, the third geometry (of frame 60) is different than the first geometry (of frame 20) and/or the second geometry (of frame 40). In some embodiments, the third geometry (of frame 60) is the same as at least one of the first geometry (of frame 20) and the second geometry (of frame 40). In some embodiments, frame 60 comprises three support members 62 forming a triangle. However, it should be appreciated that frame 60 may have any number of support members 62 forming any geometry suitable for building and expanding a custom trellis. For example, frame 60 may comprise a plurality of support members 62 forming a rectangle, square, trapezoid, hexagon, parallelogram, rhombus, etc. In some embodiments, frame 60 comprises a single support member 62 forming a circle, oval, ellipsoid, etc. Frame 60 comprises surface 64, surface 66, radially outward facing surface 68, radially inward facing surface 70, at least one hole 71, and at least one connector port 72. In some embodiments, radially outward facing surface 68 on at least one support member 62 comprises one or more radially outward extending ridges 78. Ridges 78 are operatively arranged to engage ridges on an adjacently connected frame to facilitate a tighter fit and stabilization between frames.

Connector port 72 is operatively arranged to be engaged by connector 90, 100 to connect frames 20, 40, 60 together. In some embodiments, frame 60 comprises at least two connector ports 72. In some embodiments, and as shown, connector port 72 comprises hole 74 and hole 76. Hole 74 extends from surface 64 toward surface 66. In some embodiments, hole 74 extends from surface 64 partially toward surface 66. In some embodiments, hole 74 extends from surface 64 completely to surface 66 (i.e., a through-hole extending completely through support member 62). Hole 76 extends from radially outward facing surface 68 to hole 74. In some embodiments, hole 76 extends from surface 64 partially toward surface 66. In some embodiments, hole 76 extends from surface 64 completely to surface 66 (i.e., a through-hole extending completely through support member 62). In some embodiments, and as shown, hole 74 has a first width and hole 76 has a second width, the first width being greater than the second width.

In some embodiments, frame 60 further comprises wall 67 connected to surface 66, which encloses frame 60 on a first side. As shown, frame 60 comprises at least one hole, for example two holes 71. Posts 80 are operatively arranged to engage holes 71. In some embodiments, holes 71 extend from radially outward facing surface 68 partially toward radially inward facing surface 70. In some embodiments, holes 71 extend from radially outward facing surface 68 completely to radially inward facing surface 70 (i.e., through-holes). In such through-hole embodiments, post 80 extends through holes 71 and engages wall 67, which provides added lateral support to trellis assembly 10.

FIG. 5 is a perspective view of post 80. Post 80 comprises support or rigid or semi-rigid member 82, end 84, and end 86. End 84 is operatively arranged to engage a frame, for example, frame 60. It should be appreciated, however, that post 80 may be connected to frame 20 or frame 40 as well. Specifically, end 84 engages hole 71 of frame 60. In some embodiments, post 80 is connected to frame 60 via interference fit (i.e., friction fit or press fit), namely, between support member 82 and hole 71. Such interference fit enables the removable connection between components. However, it should be appreciated that post 80 can be connected to frame 20, 40, 60 via any suitable means, for example, adhesive, soldering, welding, bolts, nails, screws, pins, etc. In some embodiments, end 84 is tapered.

End 86 is operatively arranged to engage soil or the ground in order to maintain trellis assembly 10 in a vertical position relative thereto. In some embodiments, end 86 is tapered such that post 80 can be easily inserted into the soil. In some embodiments, end 86 comprises one or more barbs 88. As shown, barbs 88 extend radially outward in a first direction from end 86 toward end 84. Barbs 88 are arranged at angle α relative to support member 82. In some embodiments, angle α is an acute angle, for example, 30 degrees. Barbs 88 increase the force required to remove posts 80 from the soil, thereby increasing the overall vertical stability of trellis assembly 10.

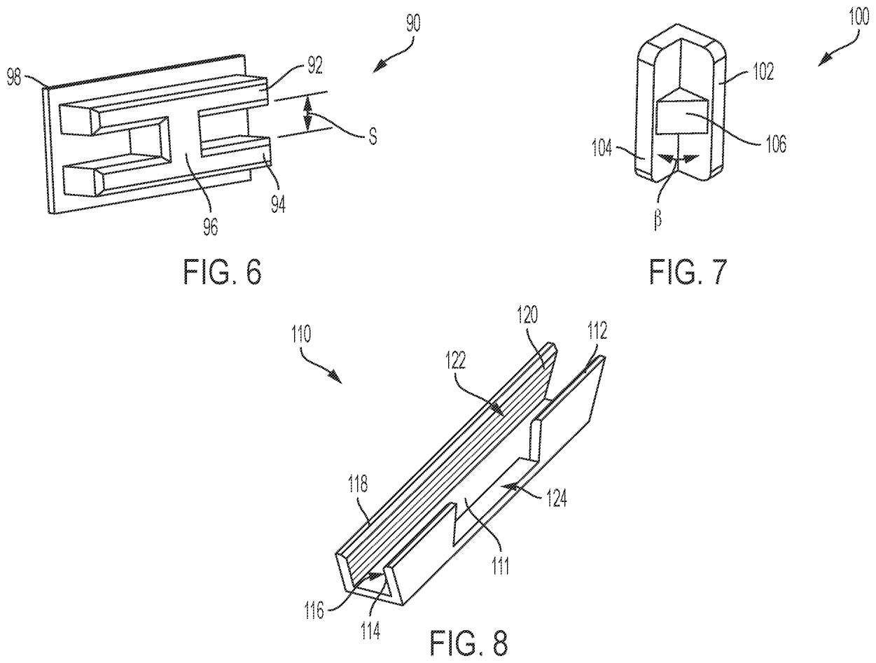

FIG. 6 is a perspective view of connector 90. Connector 90 is operatively arranged to connect frames 20, 40, and 60 together in two dimensional planes, for example, in direction D1 and direction D2 as shown in FIG. 1. Connector 90 generally comprises engaging member 92 and engaging member 94, separated from engaging member 92 by space S. Engaging members 92 and 94 are operatively arranged to engage connector ports 32, 52, and 72, specifically, holes 34, 54, and 74. In some embodiments, connector 90 further comprises engaging member 96 operatively arranged to engage holes 36, 56, and 76. For example, FIG. 1 shows connector 90 connecting two frames 20. In such connection, engaging member 92 engages hole 36 on the first frame 20, engaging member 94 engages hole 36 on the second frame 20, and engaging member 96 engages holes 36 on both frames 20, thus connecting the two frames 20. Connector 90 can also be used to interconnect frames 20, 40, and 60. FIG. 1 shows how connector ports 32, 52, and 72 are aligned prior to inserting connectors 90 therein. In some embodiments, connectors 90 are connected to connector ports 32, 52, and 72 via interference fit (i.e., friction fit or press fit), namely, between engaging members 92 and 94 and holes 34, 54, and 74. Such interference fit enables the removable connection between components. However, it should be appreciated that frames 20, 40, and 60 can be connected via any suitable means, for example, adhesive, soldering, welding, bolts, nails, screws, pins, etc.

FIG. 7 is a perspective view of connector 100. Connector 100 is operatively arranged to connect frames 20, 40, and 60 together in two dimensional planes, for example, in direction D2 and direction D3 as shown in FIG. 1. Connector 100 generally comprises engaging member 102 and engaging member 104 arranged at angle β with respect to engaging member 102. In some embodiments, angle β is equal to 90 degrees. In some embodiments, angle β is greater than or less than 90 degrees. Engaging members 102 and 104 are operatively arranged to engage connector ports 32, 52, and 72, specifically, holes 34, 54, and 74. In some embodiments, connector 100 further comprises engaging member 106 operatively arranged to engage holes 36, 56, and 76. For example, FIG. 1 shows connector 100 connecting two frames 40. In such connection, engaging member 102 engages hole 56 on the first frame 40, engaging member 104 engages hole 56 on the second frame 40, and engaging member 106 engages holes 56 on both frames 40, thus connecting the two frames 40. Connector 100 can also be used to interconnect frames 20, 40, and 60. In some embodiments, connectors 100 are connected to connector ports 32, 52, and 72 via interference fit (i.e., friction fit or press fit), namely, between engaging members 102 and 104 and holes 34, 54, and 74. Such interference fit enables the removable connection between components. However, it should be appreciated that frames 20, 40, and 60 can be connected via any suitable means, for example, adhesive, soldering, welding, bolts, nails, screws, pins, etc.

FIG. 8 is a perspective view of height indicator 110. Height indicator 110 is operatively arranged to be removably connected to frame 20, 40, 60 and indicate the original height of the plant arranged on trellis assembly 10. Indicator 110 comprises engaging member 112 and engaging member 118, which are connected to and extend from wall 111. A channel is formed between engaging members 112 and 118. Engaging member 112 comprises surface 114 and engaging member 114 comprises surface 120. Surface 114 is arranged to engage first surface 24, 44, 64 and surface 120 is arranged to engage second surface 26, 46, 66 to frictionally connect indicator to a support member 22, 42, 62. In some embodiments, surface 114 comprises ridges 116 and/or surface 120 comprises ridges 122. Ridges 116 and 122 aid in the frictional connection between components. In some embodiments, engaging member 112 further comprises hole or window 124 operatively arranged to align with and allow access to connector port 32. When assembled, wall 111 engages radially inward facing surface 30, 50, 70, engaging member 112 engages surface 24, 44, 64, and engaging member 118 engages surface 26, 46, 66. In some embodiments, indicator 110 comprises a color that is different than the color of frame 20, frame 40, frame 60, post 80, connector 90, and connector 100. Such difference in color allows a user to easily identify the degree of growth of the plant arranged on trellis assembly 10.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE NUMERALS

10 Trellis assembly
20 Frame or lattice
22 Support or rigid or semi-rigid member
24 Surface
26 Surface
28 Radially outward facing surface
30 Radially inward facing surface
32 Connector port
34 Hole
36 Hole
38 Ridges
40 Frame or lattice
42 Support or rigid or semi-rigid member
44 Surface
46 Surface
48 Radially outward facing surface
50 Radially inward facing surface
52 Connector port
54 Hole
56 Hole
58 Ridges
60 Frame or lattice or base
62 Support or rigid or semi-rigid member
64 Surface
66 Surface
68 Radially outward facing surface
70 Radially inward facing surface
71 Hole(s)
72 Connector port
74 Hole
76 Hole
78 Ridges
80 Post
82 Support or rigid or semi-rigid member
84 End
86 End
88 Barb
90 Connector
92 Engaging member
94 Engaging member
96 Engaging member
98 Wall or backing
100 Connector
102 Engaging member
104 Engaging member
106 Engaging member
110 Connector
112 Engaging member
114 Surface
116 Ridges
118 Engaging member
120 Surface
122 Ridges
124 Hole
D1 Direction
D2 Direction
D3 Direction
S Space
α Angle
β Angle

What is claimed is:

1. A trellis assembly, comprising:
at least one post including a first end and a second end; and,
a first frame removably connected to the post, the first frame including:
at least one first support member forming a first geometry;
a first front surface;
a first rear surface;
a first radially outward facing surface; and,
a first radially inward facing surface.

2. The trellis assembly as recited in claim 1, further comprising a second frame removably connectable to the first frame, the second frame including:
at least one second support member forming a second geometry;
a second front surface;
a second rear surface;
a second radially outward facing surface; and,
a second radially inward facing surface.

3. The trellis assembly as recited in claim 2, wherein the at least one second support member comprises a hole and the second end engages the hole.

4. The trellis assembly as recited in claim 2, wherein the second frame further comprises a wall connected to the second rear surface and enclosing a side of the second frame.

5. The trellis assembly as recited in claim 2, wherein the second geometry is different than the first geometry.

6. The trellis assembly as recited in claim 2, wherein the second geometry is the same as the first geometry.

7. The trellis assembly as recited in claim 1, wherein:
the first frame further comprises a first connector port;
the second frame further comprises a second connector port; and,
a connector engages the first connector port and the second connector port to removably connect the first frame to the second frame.

8. The trellis assembly as recited in claim 7, wherein at least one of the first connector port and the second connector port comprises a hole arranged in the first front surface.

9. The trellis assembly as recited in claim 7, wherein the connector comprises:
a backing;
a first engaging member protruding from the backing and operatively arranged to engage the first connector port; and,
a second engaging member protruding from the backing and spaced apart from the first engaging member, the second engaging member operatively arranged to engage the second connector port.

10. The trellis assembly as recited in claim 7, wherein the connector comprises:
a first engaging member operatively arranged to engage the first connector port; and,
a second engaging member arranged perpendicular to the first engaging member, the second engaging member operatively arranged to engage the second connector port.

11. The trellis assembly as recited in claim 1, wherein at least one of the first end and the second end is tapered.

12. The trellis assembly as recited in claim 1, wherein one of the first end and the second end comprises at least one barb.

13. The trellis assembly as recited in claim 2, further comprising a third frame removably connectable to the first frame and the second frame, wherein:
the third frame includes at least one third support member forming a third geometry; and,
the third geometry is different than the first geometry and the second geometry.

14. The trellis assembly as recited in claim 13, further comprising a plant height indicator removably connectable to the first frame, the second frame, and the third frame.

15. A trellis assembly, comprising:
a first frame, including:
at least one first support member forming a first geometry;
a first front surface; and,
a first rear surface;
a second frame removably connectable to the first frame, the second frame including:
at least one second support member forming a second geometry;
a second front surface; and,
a second rear surface; and,
at least one post including a first end and a second end removably connected to the first frame.

16. The trellis assembly as recited in claim 15, wherein the second geometry is different than the first geometry.

17. The trellis assembly as recited in claim 15, wherein:
the first front surface comprises a first connector port;
the second front surface comprises a second connector port; and,
a connector engages the first connector port and the second connector port to removably connect the first frame to the second frame.

18. The trellis assembly as recited in claim 17, wherein the connector comprises:
a backing;
a first engaging member protruding from the backing and operatively arranged to engage the first connector port; and,
a second engaging member protruding from the backing and spaced apart from the first engaging member, the second engaging member operatively arranged to engage the second connector port.

19. The trellis assembly as recited in claim 17, wherein the connector comprises:
a first engaging member operatively arranged to engage the first connector port; and,
a second engaging member arranged perpendicular to the first engaging member, the second engaging member operatively arranged to engage the second connector port.

20. The trellis assembly as recited in claim 15, further comprising a third frame removably connectable to the first frame and the second frame, wherein:
the third frame includes at least one third support member forming a third geometry; and,
the third geometry is different than the first geometry and the second geometry.
